(19) United States
(12) Patent Application Publication
(10) Pub. No.: US 2024/0403730 A1
(43) Pub. Date: Dec. 5, 2024

(54) INFORMATION PROCESSING METHOD

(71) Applicant: TOYOTA JIDOSHA KABUSHIKI KAISHA, Aichi-ken (JP)

(72) Inventors: Akihiro KANOMUNE, Tokyo-to (JP); Sho OTAKI, Yokohama-shi (JP); Takuma FUTOHASHI, Nagoya-shi (JP); Yuya KAWAI, Tokyo-to (JP)

(21) Appl. No.: 18/673,317

(22) Filed: May 24, 2024

(30) Foreign Application Priority Data
Jun. 2, 2023 (JP) 2023-091928

(51) Int. Cl. G06Q 10/02; G06Q 30/0645

(52) U.S. Cl. CPC G06Q 10/02; G06Q 30/0645

(57) ABSTRACT

An information processing method performed by an information processing apparatus, the information processing apparatus including a controller, a communication interface, and a memory, and being capable of communicating with a network via the communication interface, the information processing method including accepting a reservation for use of a vehicle in a first type of business at a first time slot, and reducing, with respect to a second time slot immediately before or immediately after the first time slot, a fee for use at the second time slot in accordance with ease of switching from the first type of business to a second type of business.

### CROSS-REFERENCE TO RELATED APPLICATION

This application claims priority to Japanese Patent Application No. 2023-091928, filed on Jun. 2, 2023, the entire contents of which are incorporated herein by reference.

### TECHNICAL FIELD

The present disclosure relates to an information processing method.

### BACKGROUND

A vehicle rental management system that sets identification data for a plurality of modes of use in a vehicle and determines a shared rental fee for the mode of use of the vehicle that has been operated based on detection result data for an actual operation status in one of the modes of use outputted from an in-vehicle device is known. For example, see Patent Literature (PTL) 1. The vehicle rental management system distributes a lease fee and a gasoline fee proportionally according to time of use of the vehicle by a plurality of users. The vehicle rental management system also shares one vehicle between “private use” and “business use” and calculates the lease fee charged to the company and the user according to the time of business use.

### CITATION LIST

### Patent Literature

PTL 1: JP 2007-114854 A

### SUMMARY

In the above background technology, fees for use based on the mode of use or the application is not considered.

It would be helpful to reduce a cost for a user.

An information processing method according to an embodiment of the present disclosure is an information processing method performed by an information processing apparatus, the information processing apparatus including a controller, a communication interface, and a memory, and being capable of communicating with a network via the communication interface, the information processing method including:
accepting a reservation for use of a vehicle in a first type of business at a first time slot; and
reducing, with respect to a second time slot immediately before or immediately after the first time slot, a fee for use at the second time slot in accordance with ease of switching from the first type of business to a second type of business.

According to an embodiment of the present disclosure, a cost for a user can be reduced.

### BRIEF DESCRIPTION OF THE DRAWINGS

In the accompanying drawings:

FIG. 1 is a schematic diagram of an information processing system;

FIG. 2 is a block diagram illustrating a configuration of an information processing apparatus;

FIG. 3 is a block diagram illustrating a configuration of a user terminal;

FIG. 4 is a flowchart illustrating operations by the information processing apparatus; and

FIG. 5 is a diagram illustrating a data structure of a fee-for-use database (DB).

### DETAILED DESCRIPTION

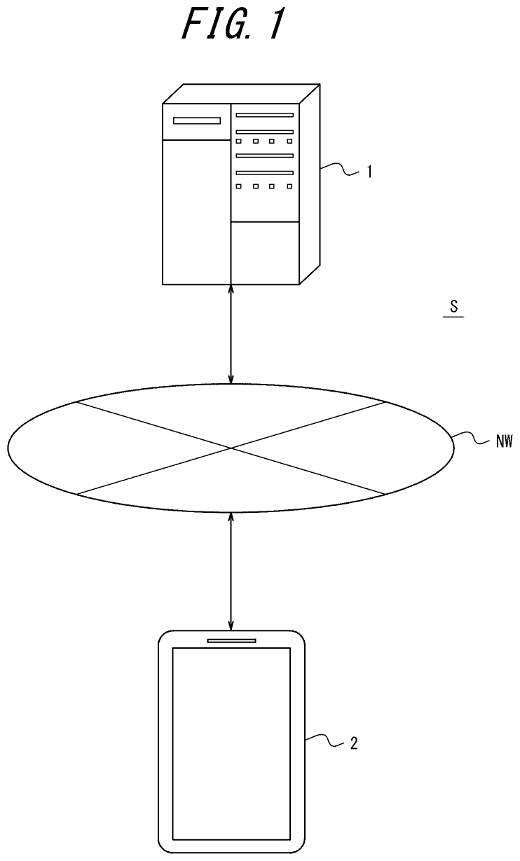

FIG. 1 is a schematic diagram of an information processing system S according to the present embodiment. The information processing system S includes an information processing apparatus 1 and a user terminal 2, which are communicably connected to each other via a network NW. The network NW includes, for example, a mobile communication network, a fixed communication network, or the Internet.

FIG. 1 illustrates one of the information processing apparatus 1 and one of the user terminal 2, for convenience of explanation. However, the number of information processing apparatuses 1 and the number of user terminals 2 are not limited to one. For example, processing to be executed by the information processing apparatus 1 according to the present embodiment may be executed by a plurality of distributed information processing apparatuses 1.

The information processing apparatus 1 is installed in a facility such as a data center. The information processing apparatus 1 is a computer such as a server that belongs to a cloud computing system or another type of computing system.

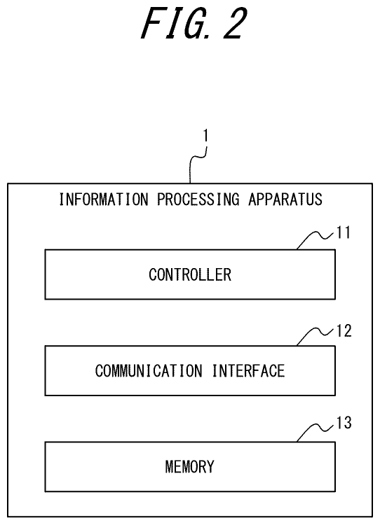

With reference to FIG. 2, an internal configuration of the information processing apparatus 1 will be described in detail.

The information processing apparatus 1 includes a controller 11, a communication interface 12, and a memory 13. The components of the information processing apparatus 1 are communicably connected to one another via, for example, dedicated lines.

The controller 11 includes, for example, one or more general purpose processors including a Central Processing Unit (CPU) or a Micro Processing Unit (MPU). The controller 11 may include one or more dedicated processors that are dedicated to specific processing. The controller 11 may include one or more dedicated circuits instead of the processors. Examples of the dedicated circuits may include a Field-Programmable Gate Array (FPGA) and an Application Specific Integrated Circuit (ASIC). The controller 11 may include an Electronic Control Unit (ECU). The controller 11 transmits and receives any information via the communication interface 12.

The communication interface 12 includes a communication module for connecting to the network NW. The communication interface 12 may include a module conforming to one or more mobile communication standards including the Long Term Evolution (LTE) standard, the 4th Generation (4G) standard, or the 5th Generation (5G) standard. The communication interface 12 may include one or more communication modules conforming to near field communication standards or specifications, including Bluetooth® (Bluetooth is a registered trademark in Japan, other countries, or both), AirDrop® (AirDrop is a registered trademark in Japan, other countries, or both), IrDA, ZigBee® (ZigBee is a registered trademark in Japan, other countries, or both), Felica® (Felica is a registered trademark in Japan, other countries, or both), or RFID. The communication interface 12 transmits and receives any information via the network NW.

The memory 13 includes, for example, a semiconductor memory, a magnetic memory, an optical memory, or a combination of at least two of these, but is not limited to these. The semiconductor memory is, for example, RAM or ROM. The RAM is, for example, SRAM or DRAM. The ROM is, for example, EEPROM. The memory 13 may function as, for example, a main memory, an auxiliary memory, or a cache memory. The memory 13 may store information resulting from analysis or processing performed by the controller 11. The memory 13 may store various types of information or the like regarding operations and control of the information processing apparatus 1. The memory 13 may store a system program, an application program, embedded software, and the like. The memory 13 may be provided outside the information processing apparatus 1 and accessed by the information processing apparatus 1. The memory 13 includes a fee-for-use DB.

The user terminal 2 is, for example, a mobile device such as a mobile phone, a smartphone, a wearable device, or a tablet. As an alternative example, the user terminal 2 may be a general purpose device such as a PC, or a dedicated device. “PC” is an abbreviation for personal computer.

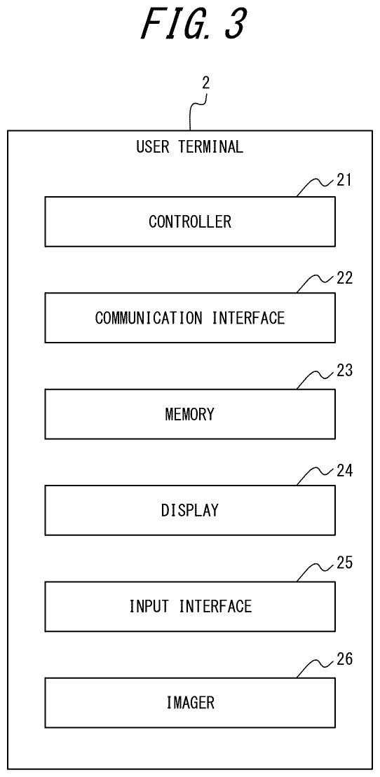

With reference to FIG. 3, an internal configuration of the user terminal 2 will be described in detail.

The user terminal 2 includes a controller 21, a communication interface 22, a memory 23, a display 24, an input interface 25, and an imager 26. The components of the user terminal 2 are communicably connected to one another, for example, via dedicated lines.

Descriptions of the hardware configurations of the controller 21, the communication interface 22, and the memory 23 of the user terminal 2 may be the same as the descriptions of the hardware configurations of the controller 11, the communication interface 12, and the memory 13 of the information processing apparatus 1, respectively. An explanation here is omitted.

The display 24 is, for example, a display. The display is, for example, an LCD or an organic EL display. The term “LCD” is an abbreviation of liquid crystal display. The term “EL” is an abbreviation of electro luminescence. The display 24, instead of being included in the user terminal 2, may be connected to the user terminal 2 as an external output device. As a connection method, for example, any technology such as USB, HDMI® (HDMI is a registered trademark in Japan, other countries, or both), or Bluetooth® can be used.

The input interface 25 is, for example, a physical key, a capacitive key, a pointing device, a touch screen integrally provided with a display, or a microphone. The input interface 25 accepts an operation for inputting information to be used for the operations of the user terminal 2. The input interface 25, instead of being included in the user terminal 2, may be connected to the user terminal 2 as an external input device. As a connection method, for example, any technology such as USB, HDMI® (HDMI is a registered trademark in Japan, other countries, or both), or Bluetooth® can be used. The term “USB” is an abbreviation of Universal Serial Bus. The term “HDMI®” is an abbreviation of High-Definition Multimedia Interface.

The imager 26 includes a camera. The imager 26 can capture images of its surroundings. The imager 26 may store the captured images in the memory 23 or transmit the captured images to the controller 21 for the purpose of image analysis. The images include still or moving images.

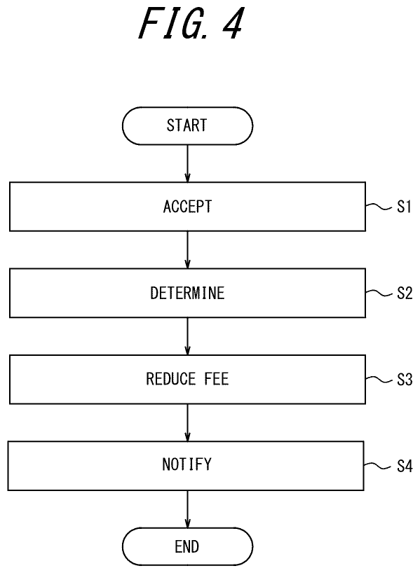

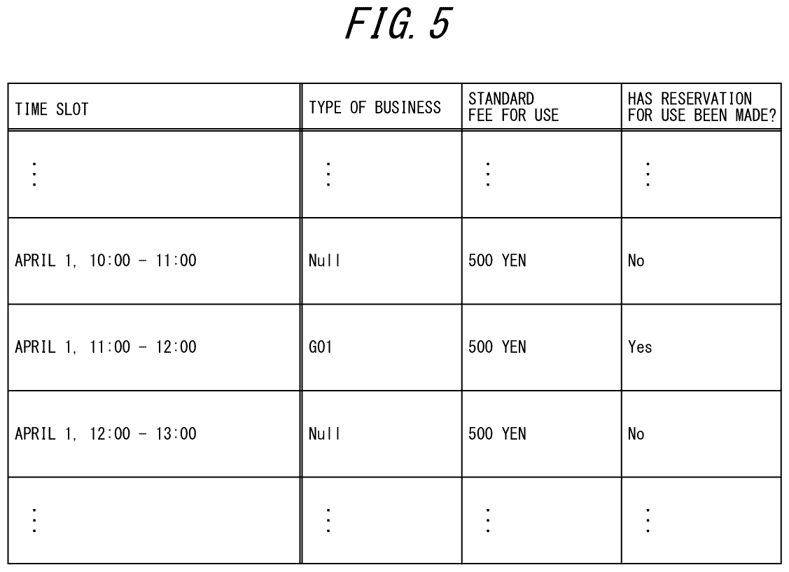

Hereinafter, in FIGS. 4 and 5, an information processing method executed by the information processing apparatus 1 will be described in detail.

In step S1, the controller 11 of the information processing apparatus 1 accepts a reservation for use of a vehicle in a first type of business at a first time slot. For example, as illustrated in FIG. 5., the controller 11 accepts a reservation for use at the first time slot from 11:00 to 12:00 on April 1 from the user terminal 2 via the network NW.

The vehicle is equipped with at least one piece of equipment for the type of business. The type of business can be any type of business, such as restaurants, coffee shops, bars, insurance sales, tutoring schools, etc. Equipment includes, for example, interiors and units.

In step S2, the controller 11 determines, with respect to a second time slot immediately before or immediately after the first time slot, the ease of switching from the first type of business to each of the one or more second types of business. Here, the first type of business and the second type of business are operated with the same vehicle, but as an alternative example, they may be operated with a different vehicle. The second time slot in the example illustrated in FIG. 5 is the time slot from 10:00 to 11:00 on April 1 or the time slot from 12:00 to 13:00 on April 1.

The switching includes the rearrangement of at least one piece of equipment. The rearrangement may be, for example, the replacement or installation of components.

As an additional or alternative example, the ease of switching is determined from the similarity between the equipment used in the first type of business and the equipment used in the second type of business. The equipment used in each type of business is stored in advance in the memory 13. The method of determining the similarity of equipment is arbitrary. For example, the controller 11 may determine that the ease of switching is low with respect to the switching from a restaurant that uses an oven to another restaurant that uses an oven, from a coffee shop to a bar, or from an insurance sales office to a tutoring school.

As an additional or alternative example, the ease of switching may be determined from the proximity between the area where the first type of business is operated and the area where the second type of business is operated. In this case, the vehicle travels from one area to another area. The area in which each type of business is operated is stored in advance in the memory 13. The method of determining the proximity of an area is arbitrary.

As an additional or alternative example, the ease of switching is determined from the similarity between the attributes of the users in the first type of business and the attributes of the users in the second type of business. The attributes of the users in each type of business are stored in advance in the memory 13. A method of determining the similarity is arbitrary.

As an additional or alternative example, the ease of switching may be determined from at least one of the time and cost required to switch. The method of determination is arbitrary. The controller 11 may determine, for example, that the less time or cost required to switch, the ease of switching is higher.

In step S3, the controller 11 reduces the fee for use at the second time slot in accordance with the determined ease. In the example illustrated in FIG. 5, the standard fee at the second time slot standard is 500 yen. As the determined ease is higher, the larger the reduction range from the 500 yen for the fee for use at the second time slot is set by the controller 11. As an additional example, the controller 11 may increase the fee for use at the second time slot as the determined ease is lower (i.e., as the switching is harder).

Upon accepting a usage request at the second time slot from the user terminal 2 or another terminal in step S4, the controller 11 notifies a different fee for use in accordance with the ease of switching from the first type of business for the type of business of the user who made the usage request. As an alternative example, the request to use at the second time slot may be accepted prior to step S3.

As described above, according to the present embodiment, the operation of the controller 11 includes accepting a reservation for use of a vehicle in a first type of business at a first time slot, and reducing, with respect to a second time slot immediately before or immediately after the first time slot, a fee for use at the second time slot in accordance with case of switching from the first type of business to a second type of business. With this configuration, the information processing apparatus 1 reduces the fee for use at the time slots before and after as easier it is to switch from the type of business for which the reservation for use has been made. Thus, the information processing apparatus 1 can reduce costs for the users and switching costs.

According to the present embodiment, the vehicle is also equipped with at least one piece of equipment in accordance with the type of business, and the switching includes rearrangement of the at least one piece of equipment. The case of switching is determined by the similarity between the equipment used in the first type of business and the equipment used in the second type of business. The case of switching is determined by the proximity between the area where the first type of business is operated and the area where the second type of business is operated. The case of switching is determined based on the similarity between the attributes of the users in the first type of business and the attributes of the users in the second type of business. With this configuration, the information processing apparatus 1 can further reduce the switching costs.

While the present disclosure has been described with reference to the drawings and examples, it should be noted that various modifications and revisions may be implemented by those skilled in the art based on the present disclosure. Other modifications can be made without departing from the spirit of the present disclosure. For example, functions or the like included in each means or each step can be rearranged without logical inconsistency, and a plurality of means or steps can be combined into one or divided.

For example, in the aforementioned embodiment, a program configured to execute all or some of the functions or processing of the information processing apparatus 1 can be recorded on a computer readable recording medium. The computer readable recording medium includes a non-transitory computer readable medium and is, for example, a magnetic recording apparatus, an optical disc, a magneto-optical recording medium, or a semiconductor memory. The program is distributed, for example, by selling, transferring, or lending a portable recording medium such as a Digital Versatile Disc (DVD) or a Compact Disc Read Only Memory (CD-ROM) on which the program is recorded. The program may also be distributed by storing the program in a storage of any server and transmitting the program from any server to another computer. The program may be provided as a program product. The present disclosure can also be implemented as a program executable by a processor.

1. An information processing method performed by an information processing apparatus, the information processing apparatus comprising a controller, a communication interface, and a memory, and being capable of communicating with a network via the communication interface, the information processing method comprising:
accepting a reservation for use of a vehicle in a first type of business at a first time slot; and
reducing, with respect to a second time slot immediately before or immediately after the first time slot, a fee for use at the second time slot in accordance with ease of switching from the first type of business to a second type of business.

2. The information processing method according to claim 1, wherein
the vehicle is equipped with at least one piece of equipment according to a type of business, and
the switching includes rearrangement of the at least one piece of equipment.

3. The information processing method according to claim 2, wherein the ease of the switching is determined based on a similarity between equipment used in the first type of business and equipment used in the second type of business.

4. The information processing method according to claim 1, wherein the ease of the switching is determined based on proximity between an area where the first type of business is operated and an area where the second type of business is operated.

5. The information processing method according to claim 1, wherein the ease of the switching is determined based on a similarity between an attribute of a user in the first type of business and an attribute of a user in the second type of business.
